(19) United States
(12) Patent Application Publication
(10) Pub. No.: US 2008/0158000 A1
(43) Pub. Date: Jul. 3, 2008

(54) Autodetect of user presence using a sensor

(76) Inventor: Daniel C. Mattrazzo, Auburndale, MA (US)

Correspondence Address: INTEL CORPORATION;c/o INTELLEVATE, LLC, P.O. BOX 52050, MINNEAPOLIS, MN, 55402, US

(21) Appl. No.: 11/648,038

(22) Filed: Dec. 28, 2006

(51) Int. Cl. G05B 11/00

(52) U.S. Cl. 340/825.25; 340/686.6; 340/584

(57) ABSTRACT

One or more sensors may be used to detect a user's presence at a listening device. Control logic may receive signals from the sensor(s) and may perform an audio related action based on the user's presence or non-presence.

### BACKGROUND

Consumer electronic devices, such as MP3 players, mobile telephones, and ultra-mobile personal computers (UMPCs), are becoming more and more popular. Use of such devices requires user awareness and interaction. For example, to play audio on an MP3 player, a button must be pressed. To pause the audio, the user must press another button, or must take another action, such as physically removing the headphone jack from the MP3 player.

### BRIEF DESCRIPTION OF THE DRAWINGS

A better understanding of embodiments of the present invention can be obtained from the following detailed description in conjunction with the following drawings, in which:

FIG. 1 is an illustration of a system according to some embodiments.

FIG. 2 is a flow diagram illustrating user presence detection according to some embodiments.

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed. For example, although some embodiments are described with respect to mobile consumer electronic devices, such as MP3 players or other portable audio players, mobile telephones, or UMPCs (ultra-mobile personal computers), embodiments may also be applicable to other types of consumer electronics as well, such as, for example, desktop computers, or any electronic device requiring user interaction.

In the following description and claims, the terms “include” and “comprise,” along with their derivatives, may be used, and are intended to be treated as synonyms for each other. In addition, in the following description and claims, the terms “coupled” and “connected,” along with their derivatives may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

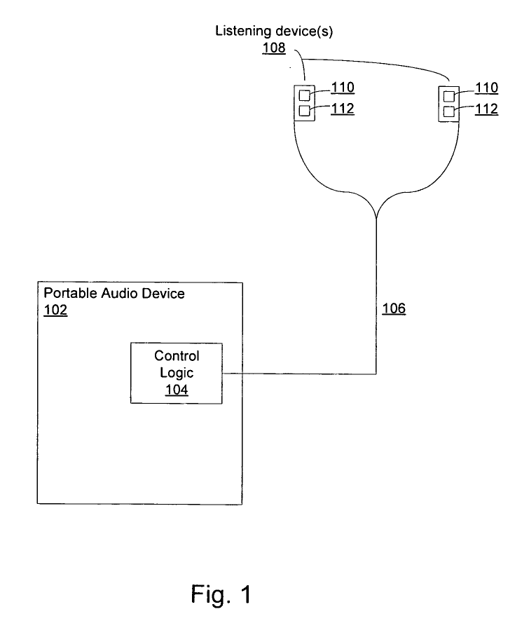

FIG. 1 illustrates a conceptual block diagram of a system according to some embodiments. The system may include a consumer electronic device, such as device 102. In some embodiments, device 102 may be a portable audio device, such as an MP3 player or other device capable of playing digital audio files. Device 102 may also be another electronic device, such as, but not limited to, a mobile telephone, an ultra-mobile personal computer (UMPC), or other electronic device capable.

The device 102 may include elements not illustrated here for simplicity, including, a memory storage device, such as a flash drive or a hard disk drive, a processor, a display, and/or a user input mechanism.

One or more speakers 110 may be integrated into the device 102, or may be included in one or more separate listening devices 108, which may be earbuds, headphones, or a headset, coupled to the device via an audio output interface. Thus, a user may listen to audio playing on device 102 through speaker(s) 110 within listening device 108.

Each of the one or more listening devices 108 may include a sensor 112 located in close proximity to a speaker 110 to detect a user's presence at the speaker. In embodiments where the speaker(s) are integrated into the device, the device itself may include one or more sensors located near the integrated speaker to detect a user's presence. In some embodiments, a sensor may be located within a range of several millimeters to several centimeters away from a speaker.

In embodiments where the listening device 108 is separate from device 102, the speaker 110 and sensor 112 may be coupled to the portable audio device by interconnect 106, which may be a wired interconnect. In other embodiments, interconnect 106 may be a wireless interconnect, such as, but not limited to, a Bluetooth wireless connection.

Interconnect 106 may couple the user presence sensor 112 to control logic 104 within the device 102. The control logic may determine whether a user is present and subsequently perform an action based on input from the sensor. For example, if the control logic detects that no user is present based on input from the sensor, the control logic may perform an action such as stopping or pausing music that is playing on the device. Further, if the control logic detects that a user is present after a period of non-presence based on input from the sensor, the control logic may perform an action such as resuming play of stopped or paused music on the device. In some embodiments, the control logic may be hardware based. In other embodiments, the control logic may be software based, or a combination of hardware and software.

Sensor 112 may be any sensor capable of providing a signal from which a user's presence or non-presence may be detected. For example, sensor 112 may be an electrical sensor, a mechanical sensor, a thermal sensor, a proximity sensor, an optical sensor, or any other sensor that is capable of providing a signal from which a user's presence or non-presence may be detected.

In one embodiment, the listening device(s) (e.g., a set of earbuds or headphones) may include one electrical sensor in each earpiece. When a user is wearing the earbuds or headphones, the control logic will detect a non-zero, low conductivity (high resistance) state from the sensors. This will indicate to the control logic that the earpieces are on a user's ears, and the device may play audio. The acceptable range of resistance may be determined so as not to obtain false positive readings when the headphones are being handled and receiving conduction through a user's hands or another part of the user's person.

The control logic may detect a high conduction sense (low resistance) when the earpieces are in direct contact with one another. This may occur when the earpieces are in a pocket or carrying case. When this state is detected, the control logic may pause or stop playing any audio.

The control logic may detect zero conductivity when the user is not wearing the earbuds/headphones, and they are not in contact with either the user's body or themselves. When this state is detected, the control logic may pause or stop playing any audio.

In another embodiment, the listening devices (e.g., a set of earbuds or headphones, or, for a mobile phone, the device itself) may include a mechanical sensor in one or more earpieces. The mechanical sensor may be, for example, a pressure switch to indicate a user's presence by whether or not pressure on the sensor is detected, or another type of mechanical sensor. When the control logic detects that there is no pressure on the mechanical sensor (i.e., a user is not present), audio may be paused or stopped. When the control logic detects that there is pressure on the mechanical sensor, audio may play or resume playing.

In yet another embodiment, the listening devices (e.g., a set of earbuds or headphones, or, for a mobile phone, the device itself) may include a thermal sensor in one or both earpieces. The thermal sensor may, for example, indicate a user's presence based on the temperature reading at the sensor. When the control logic detects that the temperature at the thermal sensor is too high or too low (i.e., a user is not present), audio may be paused or stopped. When the control logic detects that the temperature at the sensor is within an appropriate range (e.g., approximately 98.6 degrees plus or minus several degrees), audio may play or resume playing.

In yet another embodiment, the listening devices (e.g., a set of earbuds or headphones, or, for a mobile phone, the device itself) may include a proximity sensor in one or both earpieces. The proximity sensor may, for example, indicate a user's presence by the proximity of the user to the sensor. When the control logic detects that the user is out of range of the proximity sensor, audio may be paused or stopped. When the control logic detects that the user is within range of the proximity sensor, audio may play or resume playing.

In yet another embodiment, the listening devices (e.g., a set of earbuds or headphones, or, for a mobile phone, the device itself) may include an optical sensor in one or both earpieces to detect a user's presence. When the control logic detects that the user is out of range of the optical sensor, audio may be paused or stopped. When the control logic detects that the user is within range of the optical sensor, audio may play or resume playing.

In other embodiments, other types of sensors 112 may be used to detect a user's presence or non-presence and to provide the presence information to control logic 104 within a device 102.

If the device is a mobile phone including a user presence sensor, when no user presence is detected, the control logic may take an action such as playing hold music to be heard by one or more additional callers who may be on the line at the time that no user presence is detected. In another embodiment, the phone may be placed on mute when no user presence is detected. When the user presence is detected after a period of non-presence, the control logic may stop playing the hold music or unmute the mobile phone, in order to resume normal two-way telephonic communications.

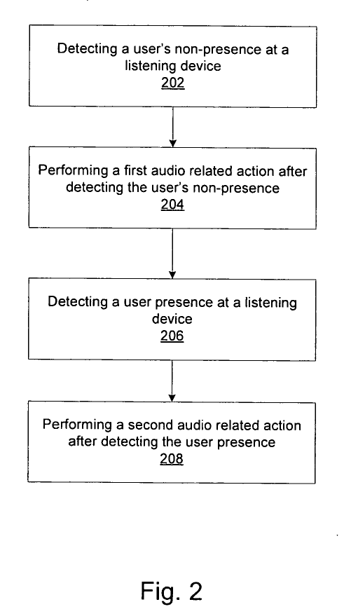

FIG. 2 is a flowchart for control logic within a device, as described above. The control logic may detect a user's non-presence at a listening device (block 202). As described above, detection may be based on input from one or more sensors included within the listening device. The one or more sensors may be electrical, mechanical, thermal, optical, proximity, or other types of sensors, or may be a combination of two or more types of sensors. Using a combination of sensors may in some cases improve accuracy of user detection. The listening device may include one or more speakers, which may be integrated into headphones (fitting over the ear) or earbuds (fitting into the ear canal), or may be integrated into a mobile device, such as a mobile telephone.

When no user presence is detected, an audio-related action will be performed (block 204). For example, when a device is playing audio, when a user's non-presence is detected, the audio playing may be paused or stopped. When the device is a two-way communication device, when no user presence is detected, the microphone of the communication device may be muted and/or audio, such as hold music, may be played for other parties who are in communication with the two-way communication device. The audio related action may be performed immediately upon detecting a user's non-presence, or may be delayed by several seconds.

The control logic may further detect when a user is present at a listening device (block 206). As described above, detection may be based on one or more sensors included within the listening device.

When a user presence is detected after a period of user non-presence, an audio related action may be performed (block 208). For example, when audio playing on a device is paused or stopped, when user's presence is detected, the audio may begin to play. When the device is a two-way communication device, when a user's presence is detected, the microphone of the communication device may be unmuted and/or audio, such as hold music, may be turned off. The audio related action may be performed immediately upon detecting a user presence, or may be delayed by several seconds.

The methods set forth above may be implemented via instructions stored on a machine-accessible medium which are executed by a processor. The instructions may be implemented in many different ways, utilizing any programming code stored on any machine-accessible medium. A machine-accessible medium includes any mechanism that provides (i.e., stores and/or transmits) information in a form readable by a machine, such as a computer. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

Thus, a method, apparatus, and system for autodetect of user presence using a sensor are disclosed in various embodiments. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

I claim:

1. A method comprising:
detecting a user's non-presence at a listening device; and
performing a first audio related action on an electronic device coupled to the listening device after detecting the user's non-presence at the listening device.

2. The method of claim 1, wherein the listening device is an earbud or a headphone and the electronic device is a portable audio device.

3. The method of claim 2, wherein the first audio related action is pausing audio.

4. The method of claim 2, wherein the first audio related action is stopping audio.

5. The method of claim 1, wherein the electronic device is a mobile telephone and the first audio related action is muting a microphone.

6. The method of claim 1, wherein the electronic device is a mobile telephone and the first audio related action is playing hold music.

7. The method of claim 1, further comprising detecting the user's presence at the listening device after detecting the user's non-presence at the listening device and performing a second audio related action on the electronic device.

8. The method of claim 7, wherein the second audio related action is playing audio.

9. The method of claim 1, wherein detecting the user's non-presence at the listening device comprises receiving a signal from a sensor and determining based on the state of the signal whether the user is present.

10. The method of claim 9, wherein the sensor is one of a mechanical sensor, an electrical sensor, an optical sensor, a proximity sensor, and a thermal sensor.

11. An apparatus comprising:
a sensor;
control logic coupled to the sensor, the control logic to detect a user's non-presence at a listening device based on a first signal received from the sensor and to perform a first audio related action upon detecting the user's non-presence at the listening device.

12. The apparatus of claim 11, wherein the control logic is further to detect a user's presence at the listening device based on a second signal received from the sensor and to perform a second audio related action upon detecting the user's presence at the listening device.

13. The apparatus of claim 12, wherein the first audio related action is pausing audio and the second audio related action is playing audio.

14. The apparatus of claim 11, wherein the sensor is one of a mechanical sensor, an electrical sensor, an optical sensor, a proximity sensor, and a thermal sensor.

15. The apparatus of claim 11, wherein the sensor is located in close proximity to a speaker.
